(19) United States
(12) Patent Application Publication
(10) Pub. No.: US 2005/0283542 A1
(43) Pub. Date: Dec. 22, 2005

(54) Method and system for programming a plurality of different memory devices during development and production with a single controllable interface tool

(76) Inventor: Xiaomao Xiao, Palo Alto, CA (US)

Correspondence Address: MCANDREWS HELD & MALLOY, LTD, 500 WEST MADISON STREET, SUITE 3400, CHICAGO, IL, 60661, US

(21) Appl. No.: 10/927,933

(22) Filed: Aug. 27, 2004

Related U.S. Application Data
(60) Provisional application No. 60/580,896, filed on Jun. 18, 2004.

(51) Int. Cl. G06F 13/00

(52) U.S. Cl. 710/8

(57) ABSTRACT

Methods and systems for programming a plurality of memory devices during development and production are provided. Aspects of the method may include receiving configuration information from the plurality of memory devices, which are coupled to a single programming host. At least one configuration instruction may be generated by the single programming host based on the received configuration information. The plurality of memory devices may be simultaneously configured via the generated at least one configuration instruction. The configuration information may be received via a communication interface, which couples the single programming host to the plurality of memory devices. The communication interface may comprise a serial or parallel interface. The communication interface may also comprise a wired or wireless interface. The method may further include determining whether each of the plurality of memory devices is a hardware and/or a software controllable device.

### CROSS-REFERENCE TO RELATED APPLICATIONS/INCORPORATION BY REFERENCE

This application makes reference to, claims priority to, and claims the benefit of U.S. Provisional Patent Application Ser. No. 60/580,896 (Attorney Docket number 15612US01), filed on Jun. 18, 2004 and entitled “Method and System For Programming a Plurality of Different Memory Devices During Development and Production With a Single Controllable Interface Tool,” the complete subject matter of which is hereby incorporated herein by reference in its entirety.

### FIELD OF THE INVENTION

Certain embodiments of the invention relate to programming memory devices during development and production. More specifically, certain embodiments of the invention relate to a method and system for programming a plurality of different memory devices during development and production with a single controllable interface tool.

### BACKGROUND OF THE INVENTION

During a typical manufacturing process of electronic devices containing memory modules, such as handsets and/or data cards, the memory modules on the devices may need to be programmed and configured. The memory modules on each electronic device may comprise a plurality of flash memory modules, where each flash memory module may be manufactured by a different vendor. In a conventional production line configuration process, different flash memory modules in a device may require different programming hosts and interfaces to perform required code or software downloads, and/or other initialization or configuration, depending on the flash memory module manufacturer. This conventional production line configuration process is time-consuming and inefficient since many programming hosts are utilized, and need to be maintained for configuring the flash memory modules from different vendors.

FIG. 1 is a block diagram of a conventional system for programming a plurality of device memory modules utilizing a plurality of programming hosts. The system 100 may comprise a handset 101, a data card 103, and programming hosts 117, 119 and 121. The handset 101 may comprise flash memory modules 105, 107, and 109. The data card 103 may comprise flash memory modules 111, 113, and 115. The data card 103 may be a wireless data card, for example.

The flash memory modules 105, 107, and 109 on the handset 101, as well as the flash memory modules 111, 113 and 115 on the data card 103 may all be manufactured by different vendors and, therefore, may each require a unique set of programming/configuration instruction during development and production. In this way, during development and production of the handset 101 and the data card 103, separate programming hosts 117, 119, and 121 may need to be utilized to program/configure different flash memory modules on the handset 101 and the data card 103. For example, programming host 117 may be utilized to program flash memory module 105 on the handset 101 and flash memory module 111 on the data card 103. Similarly, programming host 119 may be utilized to program flash memory modules 107 and 113, and programming host 121 may be utilized to program flash memory modules 109 and 115. However, programming host 117 may not be utilized to program flash memory modules 107, 109, 113 and/or 115 because, for example, their interfaces are incompatible.

Operation of the conventional system 100 during production and development of memory modules, is inefficient and time-consuming. Programming and configuration of a single electronic device, such as a handset and/or a data card, which contains different flash memory modules may take a long time since each flash memory module must be programmed by a different programming host. In addition, the conventional system 100 may be inefficient as many different programming hosts may need to be maintained, each utilizing a separate set of flash programming tools for programming flash memory devices.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for programming a plurality of memory devices during development and production. Aspects of the method may include receiving configuration information from the plurality of memory devices, which are coupled to a single programming host. At least one configuration/programming instruction may be generated by the single programming host based on the received configuration information. The configuration instruction may include configuration data, code and/or instructions that may be utilized to program, initialize or configure the memory devices. The plurality of memory devices may be simultaneously configured via the generated at least one configuration instruction. The configuration information may be received via a communication interface, which may couple the single programming host to the plurality of memory devices.

The communication interface may comprise a serial or parallel interface, which may be a wired and/or wireless interface. The method may further include determining whether each of the plurality of memory devices is a hardware and/or a software controllable device. If each of the plurality of memory devices is not a software controllable device, each of the plurality of memory devices may be initialized with configuration software. The integrity of each of the plurality of memory devices may be verified after simultaneous configuring the plurality of memory devices. The verification of integrity may utilize a 16-bit cyclic redundancy check (CRC) and/or a checksum. An identity of each of the plurality of memory devices may be acquired prior to the simultaneous configuring. The acquired identity may be validated utilizing on-chip vendor identification (ID) information, such as a vendor ID or other identifier, serial number or code.

Another embodiment of the invention may provide a machine-readable storage, having stored thereon, a computer program having at least one code section executable by a machine, thereby causing the machine to perform the steps as described above for programming a plurality of memory devices during development and production.

Aspects of the system may include at least one processor that receives configuration information from the plurality of memory devices, which are coupled to a single programming host. The processor may generate at least one configuration/programming instruction based on the received configuration information and may simultaneously configure the plurality of memory devices via the generated at least one configuration instruction. The configuration information may be received via a communication interface, which couples the at least one processor to the plurality of memory devices. The communication interface may comprise a serial or parallel interface, which may be a wired and/or wireless interface.

The processor may determine whether each of the plurality of memory devices is a hardware and/or a software controllable device. If each of the plurality of memory devices is not a software controllable device, the processor may initialize each of the plurality of memory devices with configuration software. The at least one processor may verify integrity of each of the plurality of memory devices after the simultaneous configuring. The integrity verification may utilize a 16-bit cyclic redundancy check (CRC) and/or a checksum. The at least one processor may acquire an identity of each of the plurality of memory devices prior to simultaneously configuring the plurality of memory devices. The at least one processor may validate the acquired identity utilizing on-chip vendor identification information, such as a vendor ID or other identifier, serial number and/or code.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of a conventional system for programming a plurality of device memory modules utilizing a plurality of programming hosts.

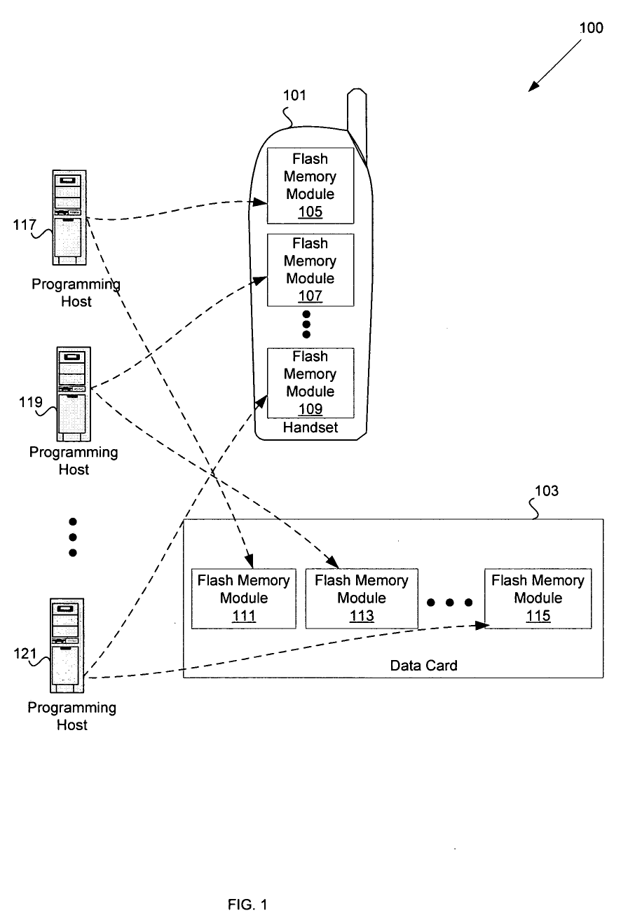

FIG. 2A is a block diagram of a flash memory device that may be utilized in accordance with an embodiment of the invention.

FIG. 2B is a block diagram of a system for programming a plurality of device memory modules utilizing a single programming host, in accordance with an embodiment of the invention.

FIG. 2C is a block diagram of a system for programming a plurality of device memory modules utilizing a transmission verification sequence, in accordance with an embodiment of the invention.

FIG. 3 is a flow diagram of an exemplary method for programming a device memory module utilizing a single programming host, in accordance with an embodiment of the invention.

FIG. 4 is a block diagram of a computer system that may be utilized in accordance with an embodiment of the invention.

### DETAILED DESCRIPTION OF THE INVENTION

Certain aspects of the invention may be found in a method and system for programming a plurality of memory devices during development and production. In one aspect of the invention, a single programming host may be coupled to a plurality of memory devices via a communication interface, such as a serial communication interface. The programming host may receive configuration information from the memory devices and may generate configuration/programming instructions based on the received configuration information. The configuration instruction may include configuration data, code and/or instructions that may be utilized to program, initialize or configure the memory devices. The configuration instructions may be communicated to the memory devices via the communication interface and may simultaneously configure the memory devices. The communication interface may be a wired and/or a wireless interface.

The configuration information received from the memory devices may indicate whether or not the memory device is software controllable, or whether the memory device is initialized with configuration software, such as a slave device software. If the memory device is not software controllable, the memory device may be initialized by the programming host and configuration software may be recorded on the memory device.

In addition, the received configuration information may validate the memory devices and may indicate whether the memory devices may be controlled by a programming host, for example. In order to verify the integrity of the simultaneously configured memory devices, the programming host may utilize a cyclic redundancy check (CRC) and/or a checksum. In one embodiment of the invention, a 16-bit CRC may be utilized. However, an 8-bit CRC, or other CRC, may be utilized as well. In this way, since only a single programming tool may be adapted to handle all programming and configuration of flash memory devices, the efficiency of production and development of memory devices may be substantially improved.

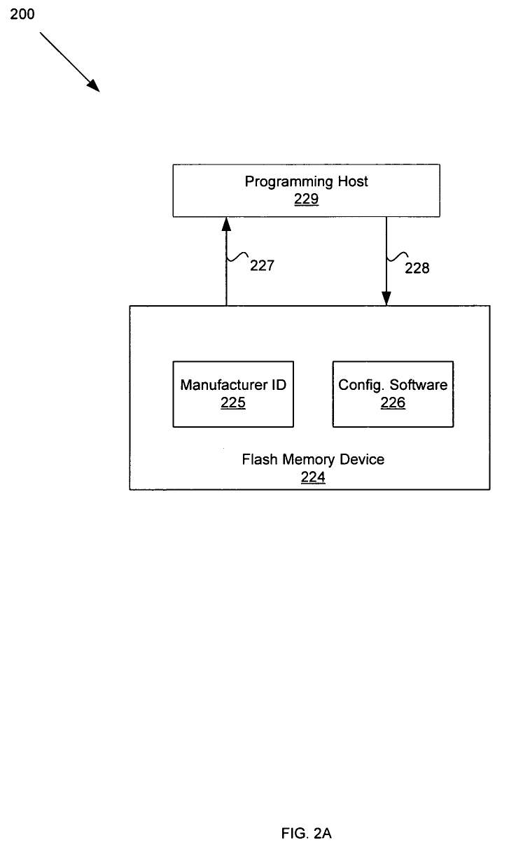

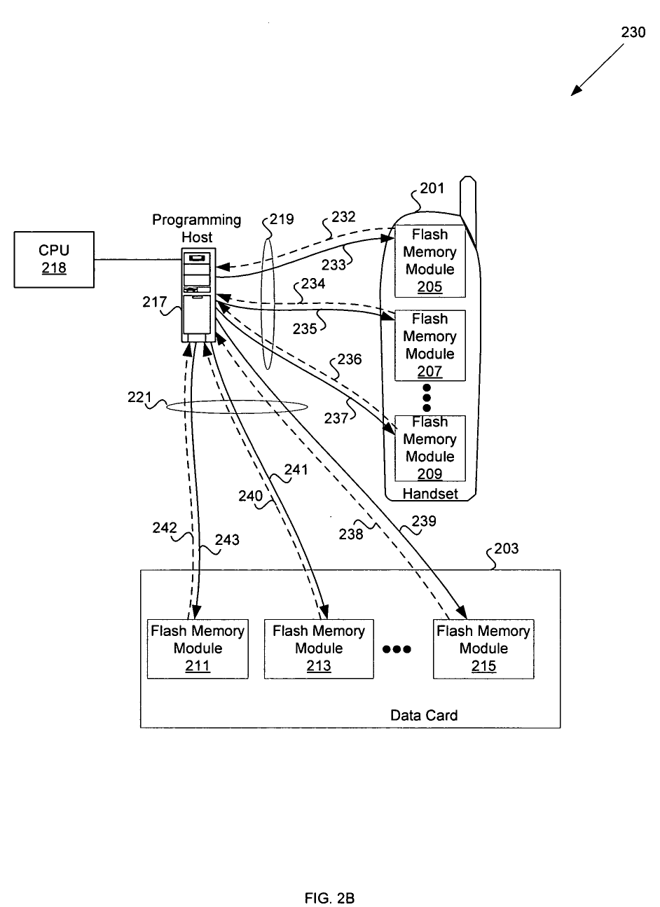

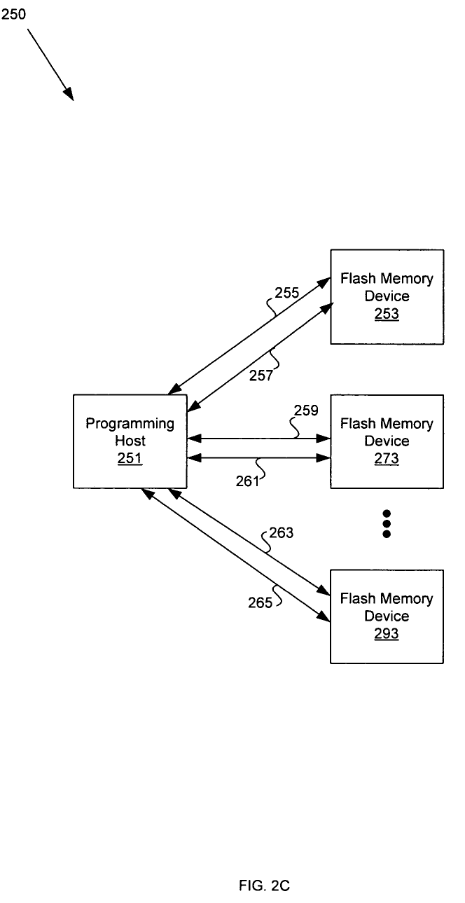

FIG. 2A is a block diagram 200 of a flash memory device 224 that may be utilized in accordance with an embodiment of the invention. Referring to FIG. 2A, the flash memory device 224 may comprise manufacturer identification information 225 and configuration software information 226. The manufacturer identification information 225 may be associated with one or more flash memory device programming characteristics. In addition the manufacturer identification information 225 may include authentication information that may be used by a programming host 229, for example, to authenticate the flash memory device 224 during development and/or production.

The configuration software information 226 may indicate whether the flash memory device 224 was initialized with configuration software by the manufacturer. For example, the configuration software information 226 may indicate whether slave software is present on the flash memory device 224.

In operation, during development and/or production, for example, the flash memory device 224 may communicate configuration information 227 to a programming host 229. The configuration information 227 may comprise manufacturer identification information 225 and/or configuration software information 226. After the flash memory device 224 communicates the manufacturer identification information 225 and the configuration software information 226 to the programming host 229, the programming host 229 may communicate a configuration/programming instruction 228 back to the flash memory device 224. In this manner, the programming host 229 may generate the configuration instruction 228 after the flash memory device 224 is authenticated by the programming host 229 via the manufacturer identification information 225. The configuration instruction 228 may also initialize the flash memory device 224 with configuration software, if the flash memory device 224 is not configured by the manufacturer, for example.

In another aspect of the invention, a configuration instruction 228 may be issued by the programming host 229 prior to receiving configuration information 227 from the flash memory device 224. A subsequent configuration instruction may then be issued after the programming host receives configuration information 227.

FIG. 2B is a block diagram of a system 230 for programming a plurality of device memory modules utilizing a single programming host, in accordance with an embodiment of the invention. The system 230 may comprise a handset 201, a data card 203, a programming host 217, and a central processing unit (CPU) 218. The handset 201 may comprise flash memory modules 205, 207, and 209. The data card 203 may comprise flash memory modules 211, 213, and 215. The data card 203 may be a wireless data card, for example. The flash memory modules 205, 207, and 209 on the handset 201, as well as the flash memory modules 211, 213 and 215 on the data card 203 may all be manufactured by different vendors and, therefore, may each require a unique set of programming/configuration instruction during development and production.

In operation, the programming host 217 may be adapted to program many types of flash memory devices, including the flash memory modules on the handset 201 and the data card 203. During development and/or production, for example, each of the flash memory devices 205, 207 and 209 on the handset 201, as well as the flash memory devices 211, 213 and 215 on the data card 203 may communicate configuration information 232, 234, 236, 242, 240 and 238, respectively, to the programming host 229. The configuration information 232, 234, 236, 242, 240 and 238 may comprise manufacturer identification information and/or configuration software information, for example. After the programming host 217 acquires the configuration information 232, 234, 236, 242, 240 and 238, the programming host may generate configuration instructions 233, 235, 237, 239, 241 and 243 for flash memory modules 205, 207, 209, 215, 213 and 211, respectively. Each of the configuration instructions 233, 235, 237, 239, 241 and 243 may correspond to manufacturer identification information and/or software configuration information communicated to the programming host 217 via the configuration information 232, 234, 236, 238, 240 and 242, respectively.

In one aspect of the invention, the programming host 217 may utilize a CPU 218 to analyze each configuration information 232, 234, 236, 238, 240 and 242 received from flash memory modules 205, 207, 209, 215, 213 and 211, respectively. After the CPU 218 analyzes the configuration information 232, 234, 236, 238, 240 and 242 and any associated manufacturer identification information and/or software configuration information within the configuration instructions, the CPU 218 may instruct the programming host 217 to generate corresponding configuration instructions 233, 235, 237, 239, 241 and 243. In this manner, the CPU 218 may detect what configuration information, if any, may be present on each flash memory device 205 through 215, and may subsequently program/configure each flash memory device only with the necessary configuration information. Configuration instructions may be simultaneously communicated from the single programming host 217 to each of the flash memory devices 205 through 215 via the communication interfaces 219 and 221.

The programming host 217 may utilize communication interfaces 219 and 221 to acquire configuration information from one or more flash memory modules and to communicate configuration instructions back to the flash memory modules. For example, configuration information 232, 234 and 236, as well as corresponding configuration instructions 233, 235 and 237 may be communicated between the programming host 217 and flash memory modules 205, 207 and 209 on the handset 201, respectively, via the communication interface 219. Similarly, configuration information 238, 240 and 242, as well as corresponding configuration instructions 239, 241 and 243 may be communicated between the programming host 217 and flash memory modules 215, 213 and 211 on the data card 203, respectively, via the communication interface 221. The communication interfaces 219 and 221 may comprise a wireless and/or a wired communication interface, for example.

The programming host 217 may initially receive configuration information from each flash memory device on the handset 201, via the communication interface 219, and on the data card 203, via the communication interface 221. The received configuration information may indicate whether initializing/configuration software, such as a slave device software, may be present on each of the flash memory modules 205 through 215. In addition, the received configuration information may include flash memory device manufacturer identification information and may be utilized by the programming host 217 to initially authenticate each flash memory device prior to subsequent programming and development.

The system 230 may utilize the programming host 217 and the CPU 218 in different configurations. For example, the programming host 217 and the CPU 218 may be utilized in a one-to-many configuration, such as a production line. In a one-to-many configuration, the programming host 217 and the CPU 218 may be utilized for simultaneous programming/configuration of multiple memory devices. However, the present invention may not be limited by the number of memory devices a single programming host may be utilized to program. For example, the programming host 217 and the CPU 218 may also be utilized in a one-to-one configuration during programming and/or development stages of memory devices. In a one-to-one configuration, the programming host 217 may be utilized for configuration/development of a single memory device.

FIG. 2C is a block diagram of a system 250 for programming a plurality of device memory modules utilizing a transmission verification sequence, in accordance with an embodiment of the invention. Referring to FIG. 2C, the system 250 may comprise a programming host 251 and a plurality of flash memory devices 253, 273 and 293.

In operation, the programming host 251 may be adapted to receive configuration information from the flash memory modules 253, 273 and 293. The programming host may subsequently communicate one or more configuration instructions to the memory modules 253, 273 and 293, respectively. The programming host 251 may utilize one or more transmission verification sequences to verify the integrity of data transmission between the programming host 251 and the flash memory devices 253, 273 and 293. For example, checksum sequences 255, 259 and 263 may be used to verify data transmission integrity between the programming host 251 and the flash memory devices 253, 273 and 293, respectively. In addition, 16-bit, or other value, cyclic redundancy check (CRC) sequences 257, 261 and 265 may also be utilized to verify the correctness of a programming session between the programming host 251 and flash memory devices 253, 273 and 293. In this manner, the use of checksum sequences 255, 259 and 263, and/or CRC sequences 257, 261 and 265 may result in significant reduction in data verification times within the system 250.

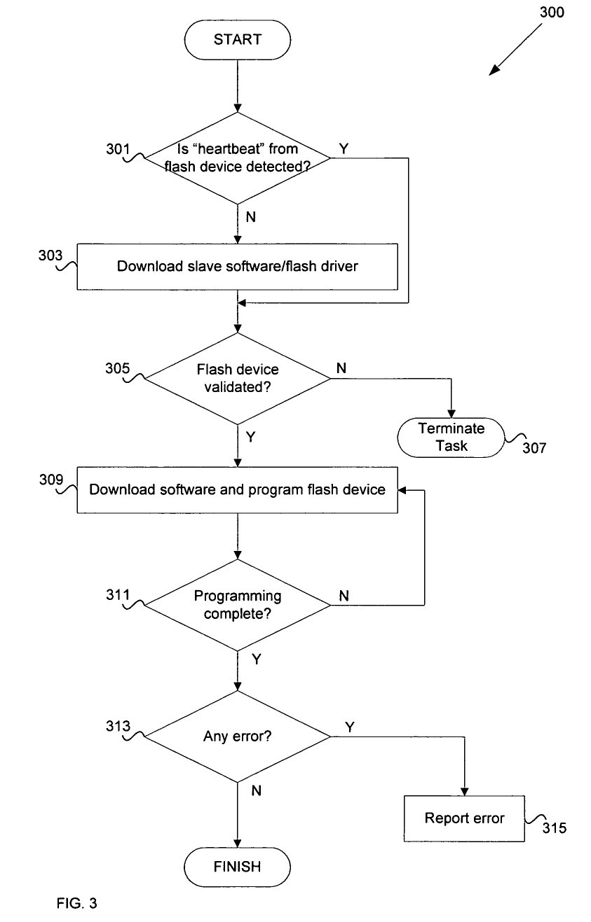

FIG. 3 is a flow diagram of an exemplary method 300 for programming a device memory module utilizing a single programming host, in accordance with an embodiment of the invention. The method 300 may be utilized in a one-to-many configuration, for example, for simultaneous programming/configuration of multiple flash memory devices. At 301, a programming host may receive configuration information from a memory device and it may be determined whether a “heartbeat” is present. A “heartbeat” may be present if the received configuration information indicates the presence of initialization/configuration software, such as a slave device software/driver, at the memory device. If no “heartbeat” is detected, or no slave software/driver is present at the memory device, at 303 a slave software/flash driver may be downloaded to the memory device. At 305, it may be determined whether the flash memory device is a valid device.

The validation process may utilize a manufacturer identification information that may be pre-stored on the memory device and subsequently read by the programming host. If the flash memory device is not validated, at 307, the programming/configuration task may be terminated. If the flash memory device is validated, at 309 the programming host may download any necessary software to the flash memory device that may be required for programming/configuration. At 311, it may be determined whether programming/configuration is complete. If programming/configuration is not complete, then 309 may be repeated. At 313, it may be determined whether there were any errors during the data transmission between the programming host and the memory device. Such error determination may be achieved by utilizing a checksum and/or a CRC, for example. If transmission errors have been detected, at 315, the errors may be reported.

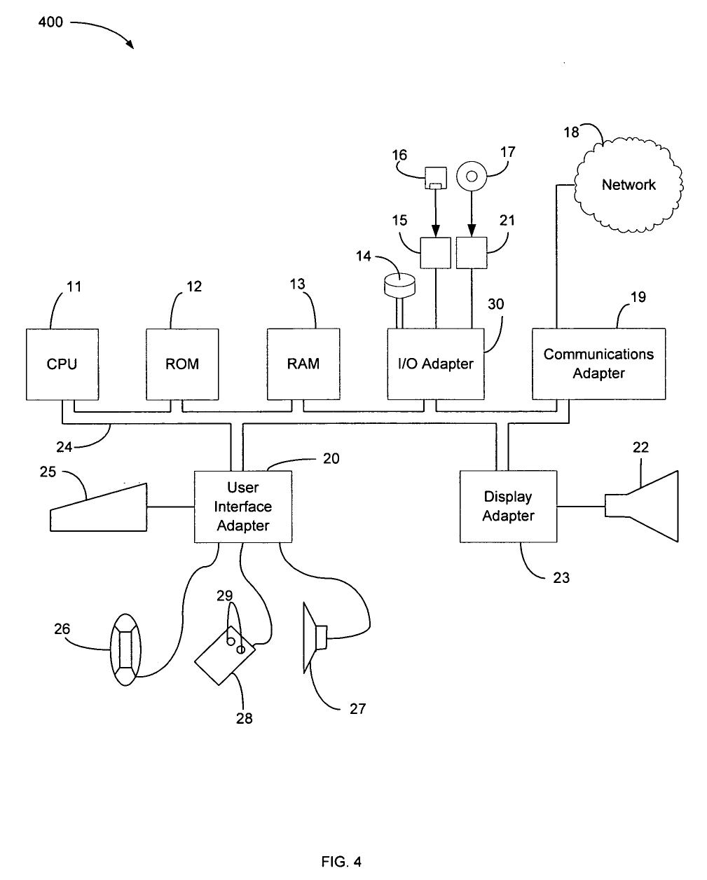

FIG. 4 is a block diagram of a computer system 400 that may be utilized in accordance with an embodiment of the invention. The computer system 400 may comprise a central processing unit (CPU) 11, a random access memory (RAM) 13, a read only memory (ROM) 12, an input/output (I/O) adapter 30, a user interface adapter 20, a communications adapter 19, and a display adapter 23. One or more elements of the computer system 400 may be implemented on a single chip. The CPU 11 may be integrated as a host processor, for example.

The I/O adapter 30 may connect to a bus 24 peripheral devices, such as hard disk drives 14, magnetic disk drives 15 for reading removable magnetic disks 16, and/or optical disk drives 21 for reading removable optical disks 17, such as a compact disk or a digital versatile disk. The user interface adapter 20 may connect to the bus 24 devices such as a keyboard 25, a mouse 28 having a plurality of buttons 29, a speaker 27, a microphone 26, and/or other user interface devices, such as a touch screen device (not shown). The communications adapter 19 may connect the computer system 400 to a data processing network 18. The display adapter 23 may connect a monitor 22 to the bus 24.

In one aspect of the invention, the CPU 11 may be integrated as a processor within a system for programming a plurality of device memory modules utilizing a single programming host, such as the CPU 218 of FIG. 2B. In this manner, the computer system 400 may be utilized for programming a plurality of memory devices during development and production. Aspects of the system 400 may include a CPU 11 that receives configuration information from the plurality of memory devices, which may be coupled to a single programming host. The CPU 11 may generate at least one configuration instruction based on the received configuration information and may simultaneously configure the memory devices via the generated configuration instruction. The configuration information may be received by the CPU 11 via a communication interface, which may couple the CPU 11 to the memory devices. The communication interface may comprise a serial or parallel interface, which may be a wired and/or a wireless interface.

The CPU 11 may determine whether each memory device is a hardware and/or a software controllable device. If each memory device is not software controllable, the CPU 11 may initialize each memory device with configuration software. The CPU 11 may verify integrity of each memory device after the simultaneous configuring. The integrity verification may utilize a 16-bit cyclic redundancy check (CRC) and/or a checksum. The CPU 11 may acquire an identity of each memory device prior to the simultaneous configuration of the memory devices. The CPU 11 may validate the acquired identity utilizing on-chip vendor identification information, such as a vendor ID or other identifier, serial number and/or code.

An embodiment of the invention may be implemented as sets of instructions resident in the RAM 13 of one or more computer systems 400 configured generally as described in FIG. 4. Until required by the computer system 400, the sets of instructions may be stored in another computer readable memory, for example on a hard disk drive 14, or in a removable media or other memory, such as an optical disk 17 for eventual use in an optical disk drive 21, or in a magnetic disk 16 for eventual use in a magnetic disk drive 15. The physical storage of the sets of instructions may physically change the medium upon which it is stored electrically, magnetically, or chemically, so that the medium carries computer readable information.

Accordingly, aspects of the invention may be realized in hardware, software, firmware or a combination thereof. The invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

1. A method for programming a plurality of memory devices during development and production, the method comprising:
receiving configuration information from the plurality of memory devices, which are coupled to a single programming host;
generating at least one configuration instruction by said single programming host based on said received configuration information; and
simultaneously configuring the plurality of memory devices via said generated at least one configuration instruction.

2. The method of claim 1, wherein said configuration information is received via a communication interface, which couples said single programming host to the plurality of memory devices.

3. The method of claim 2, wherein said communication interface comprises a serial or parallel interface.

4. The method of claim 2, wherein said communication interface comprises a wireless or wired interface.

5. The method of claim 1, further comprising determining whether each of the plurality of memory devices is a hardware controllable device.

6. The method of claim 1, further comprising determining whether each of the plurality of memory devices is a software controllable device.

7. The method of claim 6, further comprising, if said each of the plurality of memory devices is not a software controllable device, initializing said each of the plurality of memory devices with configuration software.

8. The method of claim 1, further comprising verifying integrity of each of the plurality of memory devices after said simultaneous configuring of the plurality of memory devices.

9. The method of claim 8, wherein said verification of integrity utilizes at least one of a cyclic redundancy check (CRC) and a checksum.

10. The method of claim 1, further comprising acquiring an identity of each of the plurality of memory devices prior to said simultaneous configuring.

11. The method of claim 10, further comprising validating said acquired identity utilizing on-chip vendor identification (ID) information.

12. A machine-readable storage having stored thereon, a computer program having at least one code section for programming a plurality of memory devices during development and production, the at least one code section being executable by a machine for causing the machine to perform steps comprising:
receiving configuration information from the plurality of memory devices, which are coupled to a single programming host;
generating at least one configuration instruction by said single programming host based on said received configuration information; and
simultaneously configuring the plurality of memory devices via said generated at least one configuration instruction.

13. The machine-readable storage of claim 12, wherein said configuration information is received via a communication interface, which couples said single programming host to the plurality of memory devices.

14. The machine-readable storage of claim 13, wherein said communication interface comprises a serial or parallel interface.

15. The machine-readable storage of claim 13, wherein said communication interface comprises a wired or wireless interface.

16. The machine-readable storage of claim 12, further comprising code for determining whether each of the plurality of memory devices is a hardware controllable device.

17. The machine-readable storage of claim 12, further comprising code for determining whether each of the plurality of memory devices is a software controllable device.

18. The machine-readable storage of claim 17, further comprising, if said each of the plurality of memory devices is not a software controllable device, code for initializing said each of the plurality of memory devices with configuration software.

19. The machine-readable storage of claim 12, further comprising code for verifying integrity of each of the plurality of memory devices after said simultaneous configuring of the plurality of memory devices.

20. The machine-readable storage of claim 19, wherein said verification of integrity utilizes at least one of a cyclic redundancy check (CRC) and a checksum.

21. The machine-readable storage of claim 12, further comprising code for acquiring an identity of each of the plurality of memory devices prior to said simultaneous configuring.

22. The machine-readable storage of claim 21, further comprising code for validating said acquired identity utilizing on-chip vendor ID information.

23. A system for programming a plurality of memory devices during development and production, the system comprising:
at least one processor that receives configuration information from the plurality of memory devices, which are coupled to a single programming host;
the at least one processor generates at least one configuration instruction based on said received configuration information; and
the at least one processor simultaneously configures the plurality of memory devices via said generated at least one configuration instruction.

24. The system of claim 23, wherein said configuration information is received via a communication interface, which couples said at least one processor to the plurality of memory devices.

25. The system of claim 24, wherein said communication interface comprises a serial or parallel interface.

26. The system of claim 24, wherein said communication interface comprises a wired or wireless interface.

27. The system of claim 23, wherein the at least one processor determines whether each of the plurality of memory devices is a hardware controllable device.

28. The system of claim 23, wherein the at least one processor determines whether each of the plurality of memory devices is a software controllable device.

29. The system of claim 28, wherein, if said each of the plurality of memory devices is not a software controllable device, the at least one processor initializes said each of the plurality of memory devices with configuration software.

30. The system of claim 23, wherein the at least one processor verifies integrity of each of the plurality of memory devices after said simultaneous configuring of the plurality of memory devices.

31. The system of claim 30, wherein said verification of integrity utilizes at least one of a cyclic redundancy check (CRC) and a checksum.

32. The system of claim 23, wherein the at least one processor acquires an identity of each of the plurality of memory devices prior to said simultaneous configuring.

33. The system of claim 32, wherein the at least one processor validates said acquired identity utilizing on-chip vendor ID information.
